(19) United States
(12) Patent Application Publication
(10) Pub. No.: US 2023/0001300 A1
(43) Pub. Date: Jan. 5, 2023

(54) COMPUTER SYSTEM, GAME SYSTEM, AND CONTROL METHOD OF COMPUTER SYSTEM

(71) Applicant: BANDAI NAMCO ENTERTAINMENT INC., Tokyo (JP)

(72) Inventors: Kohei IKEDA, Kawasaki-shi (JP); Yusuke TSUTSUMI, Tokyo (JP)

(73) Assignee: BANDAI NAMCO ENTERTAINMENT INC., Tokyo (JP)

(21) Appl. No.: 17/939,825

(22) Filed: Sep. 7, 2022

Related U.S. Application Data
(63) Continuation of application No. PCT/JP2021/009454, filed on Mar. 10, 2021.

(30) Foreign Application Priority Data
Mar. 10, 2020 (JP) 2020-041078

(51) Int. Cl. A63F 13/58; A63F 13/53

(52) U.S. Cl. CPC A63F 13/58; A63F 13/53

(57) ABSTRACT

A computer system performs, with a player operating a player character as a target player, an individual evaluation of gameplay of the target player for each stat item based on motion content or a motion result of the player character during a game. The computer system further performs an overall evaluation of each stat item based on a result of the individual evaluation of each stat item of each player. The computer system further controls comparison display of the result of the individual evaluation of each stat item of the target player and a result of the overall evaluation.

### CROSS REFERENCE TO RELATED APPLICATION

This application is a continuation of International Patent Application No. PCT/JP2021/009454, having an international filing date of Mar. 10, 2021, which designated the United States, the entirety of which is incorporated herein by reference. Japanese Patent Application No. 2020-041078 filed on Mar. 10, 2020 is also incorporated herein by reference in its entirety.

### BACKGROUND

There have been games providing fun for a player operating a character to have a match with an opponent character (see Patent Document 1, for example). In some games of this kind, gameplay of the player is evaluated and presented to the player. For example, statistics, or stats, of the match are analyzed at the end of the match to be presented to the player.

However, the stats are conventionally displayed only to show an evaluation result of the gameplay of the player.

### BRIEF DESCRIPTION OF THE DRAWINGS

FIG. 1 is a diagram illustrating an example of a general configuration of a game system.

FIG. 2 is a diagram illustrating an example of a device configuration of a player terminal.

FIG. 3 is a table illustrating an example of a data configuration of a stat item setting table.

FIG. 4 is a table illustrating an example of a data configuration of a rank conversion table.

FIG. 5 is a diagram illustrating an example of a data configuration of player-specific individual evaluation data.

FIG. 6 is a diagram illustrating an example of a data configuration of overall evaluation data.

FIG. 7 is a diagram illustrating an example of a player-to-all comparison display.

FIG. 8 is a table illustrating an example of a data configuration of display body definition data.

FIG. 9 is a diagram illustrating an example of a player-to-player comparison display.

FIG. 10 is a block diagram illustrating an example of a functional configuration of a server system.

FIG. 11 is a diagram illustrating an example of programs and data stored in a server storage section.

FIG. 12 is a diagram illustrating an example of a data configuration of match play data.

FIG. 13 is a block diagram illustrating an example of a functional configuration of the player terminal.

FIG. 14 is a flowchart illustrating a flow of processes in the server system.

FIG. 15 is a diagram illustrating an example of a player-to-player comparison display in a modification example.

### DESCRIPTION OF EXEMPLARY EMBODIMENTS

The following disclosure provides many different embodiments, or examples, for implementing different features of the provided subject matter. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed. Further, when a first element is described as being “connected” or “coupled” to a second element, such description includes embodiments in which the first and second elements are directly connected or coupled to each other, and also includes embodiments in which the first and second elements are indirectly connected or coupled to each other with one or more other intervening elements in between.

A first disclosure is a computer system comprising:

at least one processor or circuit programmed to perform:

an individual evaluation of gameplay of a target player for each stat item based on any one of motion content and a motion result of a player character during a game, the target player being a player operating the player character;

an overall evaluation of the each stat item based on a result of the individual evaluation of the each stat item of each player; and

a first comparison display control for performing comparison display of the each stat item between the result of the individual evaluation and a result of the overall evaluation in relation to the target player.

According to the disclosure, in some embodiments, the individual evaluation of the gameplay of the target player can be performed for each stat item, the overall evaluation of each stat item can be performed based on the result of the individual evaluation of each stat item of each player, and the comparison display between the result of the individual evaluation and the result of the overall evaluation can be performed. Accordingly, the result of the individual evaluation of each stat item of the target player and the result of the overall evaluation of each stat item can be presented in a comparable manner to the target player.

A second disclosure is the computer system, wherein performing the individual evaluation includes

performing the individual evaluation for every gameplay of the game, and

aggregating results of the individual evaluation of the each stat item of every gameplay in relation to the target player so as to calculate through aggregation the result of the individual evaluation of the each stat item of the target player.

According to the disclosure, in some embodiments, the results of the individual evaluation of every gameplay of the game performed by the target player can be aggregated for each stat item so as to calculate the result of the individual evaluation of each stat item of the player.

A third disclosure is the computer system 1, wherein

the player character is a used character selected from a predetermined character group by the player and used in the game by the player,

performing the individual evaluation includes performing the individual evaluation according to a type of used character,

performing the overall evaluation includes performing the overall evaluation according to the type of used character, and

performing the first comparison display control includes performing the comparison display according to the used character of the target player.

According to the disclosure, in some embodiments, the individual evaluation and the overall evaluation can be performed according to the type of used character used in the match, and the result of the individual evaluation and the result of the overall evaluation can be displayed in a comparable manner according to the type of used character so as to be presented to the target player.

A fourth disclosure is the computer system, wherein

the player character is a used character selected from a predetermined character group by the player and used in the game by the player,

the game is a match game where characters selected from the character group have a match,

performing the individual evaluation includes performing the individual evaluation according to a combination of a type of the used character and a type of a opponent character,

performing the overall evaluation includes performing the overall evaluation according to the combination of the type of the used character and the type of the opponent character, and

performing the first comparison display control includes performing the comparison display according to the combination of the used character of the target player and the opponent character in the match.

According to the disclosure, in some embodiments, the individual evaluation and the overall evaluation can be performed according to the combination of the type of used character used in the match and the type of opponent character of an opponent, and the result of the individual evaluation and the result of the overall evaluation can be displayed in a comparable manner according to the combination so as to be presented to the target player.

A fifth disclosure is the computer system, wherein the at least one processor or circuit is further programmed to perform

a second comparison display control for performing comparison display between a result of the individual evaluation of the each stat item of a first player and a result of the individual evaluation of the each stat item of a second player.

According to the disclosure, in some embodiments, the results of the individual evaluation of each stat item of any two players can be displayed in a comparable manner. Accordingly, the result of the individual evaluation of each stat item of the player can be presented to the player in a comparable manner with the result of the individual evaluation of each stat item of another player who is the opponent.

A sixth disclosure is the computer system, wherein the at least one processor or circuit is further programmed to perform

a third comparison display control for performing comparison display of the each stat item between a result of the individual evaluation at first timing and a result of the individual evaluation at second timing in relation to the target player.

According to the disclosure, in some embodiments, the results of the individual evaluation of each stat item individually evaluated at different timing can be presented to the target player in a comparable manner.

A seventh disclosure is the computer system 1, wherein

the game is a match game where characters selected from a predetermined character group have a match, and a game setting relating to the match is variable,

performing the individual evaluation includes performing the individual evaluation according to a variable game setting,

performing the overall evaluation includes performing the overall evaluation according to the variable game setting, and

performing the first comparison display control includes performing the comparison display according to the game setting of the target player.

An eighth disclosure is the computer system, wherein the game setting is at least any one of a limited time period, a number of rounds, and a type of game stage of the match.

According to the disclosure, in some embodiments, the individual evaluation and the overall evaluation can be performed according to the game setting such as the limited time period, the number of rounds, and the type of game stage of the match, and the result of the individual evaluation and the result of the overall evaluation can be displayed in a comparable manner according to the game setting so as to be presented to the target player.

A ninth disclosure is the computer system 1, wherein

the game is a match game where characters selected from a predetermined character group have a match, and a game event relating to the match is held,

performing the individual evaluation includes performing the individual evaluation according to a type of the game event,

performing the overall evaluation includes performing the overall evaluation according to the type of the game event, and

performing the first comparison display control includes performing the comparison display according to the type of the game event of the target player.

According to the disclosure, in some embodiments, the individual evaluation and the overall evaluation of the match in the game event can be performed according to the type of game event, and the result of the individual evaluation and the result of the overall evaluation can be displayed in a comparable manner according to the type of game event so as to be presented to the target player.

A tenth disclosure is a game system comprising:

a player terminal of each player; and

a server system that is any one of the above computer systems configured to be able to communicate with the player terminal.

According to the disclosure, in some embodiments, the game system that can exert the effects described above can be implemented.

Preferred embodiments of the present disclosure are hereinafter described referring to the drawings. However, the present disclosure is not limited by the following embodiments, and the modes to which the present disclosure is applicable are not limited to the following embodiments. In addition, common reference signs are given to identical components in the drawings.

[General Configuration]

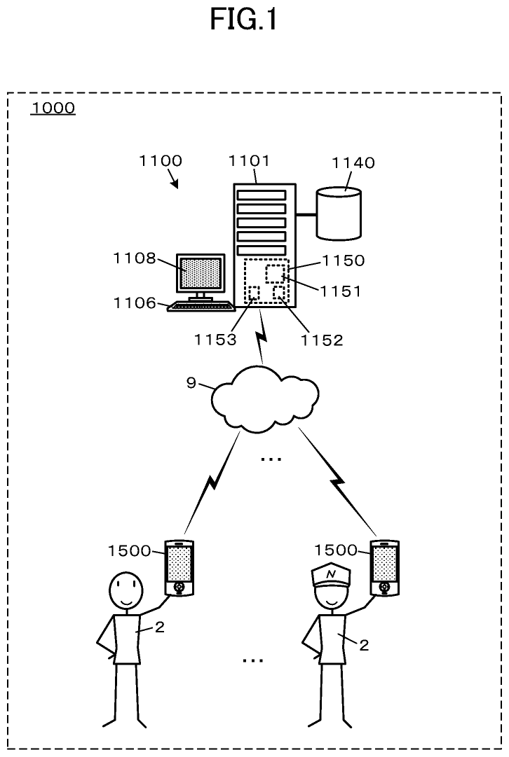

FIG. 1 is a diagram illustrating an example of a general configuration of a game system 1000 according to the present embodiment. As illustrated in FIG. 1, the game system 1000 includes a server system 1100 as a computer system and a player terminal 1500 possessed by a player (a user) 2 who plays a game according to the present embodiment. The server system 1100 and the player terminal 1500 are connected to perform data communication with each other via a network 9.

The network 9 is a communication channel capable of data communication. Specifically, the network 9 includes a communication network such as a local area network (LAN) using a private line (a private cable) for direct connection or Ethernet (registered trademark), a telecommunication network, a cable network, or an Internet. A communication method may be a cable communication method or a wireless communication method.

The server system 1100 includes a main body device 1101, a keyboard 1106, a touch panel 1108, and a storage 1140. The main body device 1101 includes a control board 1150 on which mounted are electronic components including a microprocessor of various types such as a central processing unit (CPU) 1151, a graphics processing unit (GPU), or a digital signal processor (DSP), an IC memory 1152 of various types such as a VRAM, a RAM, or a ROM, or a communication device 1153. The control board 1150 may be entirely or partially implemented by an application specific integrated circuit (ASIC), a field-programmable gate array (FPGA), or a system on a chip (SoC).

Through a calculation process performed by the CPU 1151 or the like based on a predetermined program and data, the server system 1100 implements a user management function related to user registration or the like and a game management function of providing data required to play the game with the player terminal 1500 to manage an execution control on the game played with the player terminal 1500. That is, the game according to the present embodiment is implemented as a kind of client-server online game. The player 2 uses his/her own player terminal 1500 to access the server system 1100 and log in with an issued account (a player ID) to play the game according to the present embodiment.

The server system 1100 is not limited to a single server configuration illustrated in FIG. 1, and may be configured such that a plurality of blade servers sharing the functions are connected via an internal bus to perform data communication. Alternatively, the server system 1100 may be configured such that a plurality of independent servers installed at separate places perform data communication via the network 9 to serve as the server system 1100 as a whole.

The player terminal 1500 is a computer system that functions as a man-machine interface, and connects to the network 9 via a mobile phone base station, a wireless communication base station, or the like to perform data communication with the server system 1100. The player terminal 1500 may be implemented as, for example, a smartphone, a mobile phone, a portable game device, a stationary consumer game device, a controller of the stationary consumer game device, an arcade game apparatus, a personal computer, a tablet computer, or a wearable computer.

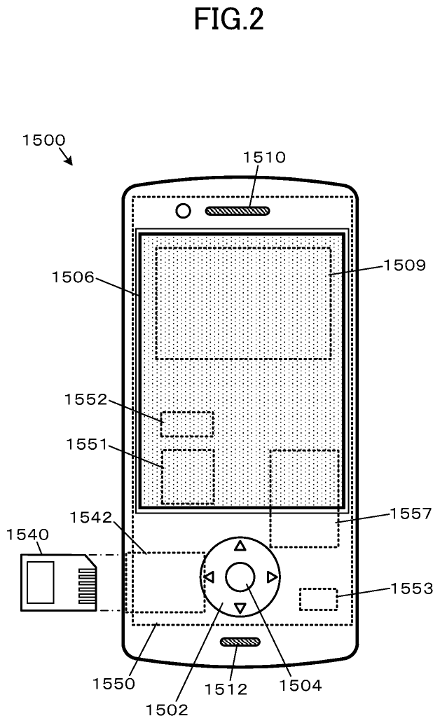

FIG. 2 is a diagram illustrating an example of a device configuration of a smartphone serving as the player terminal 1500. As illustrated in FIG. 2, the player terminal 1500 includes an arrow key 1502, a home key 1504, a touch panel 1506 that functions as an image display device and a touch position input device, a built-in battery 1509, a speaker 1510, a microphone 1512, a control board 1550, and a memory card reader 1542 that can write and read data on and from a memory card 1540 that is a computer readable storage medium. The player terminal 1500 further includes a power button, a volume control button, or the like (not illustrated).

The control board 1550 includes, for example, a microprocessor of various types such as a CPU 1551, a GPU, or a DSP, an IC memory 1552 of various types such as a VRAM, a RAM, or a ROM, and a wireless communication module 1553 for performing wireless communication with a mobile phone base station, a wireless LAN base station, or the like connected to the network 9. The control board 1550 includes so-called I/F circuits (interface circuits) 1557 including a circuit that receives signals from the arrow key 1502 and the home key 1504, a driver circuit for the touch panel 1506, an output amplifier circuit that outputs sound signals to the speaker 1510, an audio signal generation circuit that generates signals corresponding to sounds collected by the microphone 1512, or a signal input-output circuit that inputs and outputs signals to and from the memory card reader 1542, for example. These elements included in the control board 1550 are electrically connected through a bus circuit or the like so that the elements can read and write data and exchange signals. The control board 1550 may partially or entirely be implemented by an ASIC, an FPGA, or an SoC.

The IC memory 1552 in the control board 1550 stores, for example, a game client program and various types of setting data required to execute the game client program. The game client program or the like is downloaded from the server system 1100 at appropriate timing. Alternatively, the game client program or the like may be read out from a storage medium such as the memory card 1540 separately provided. The CPU 1551 or the like executes the game client program to perform a calculation process, and controls each section of the player terminal 1500 to enable gameplay of the player 2 in accordance with operation input with the touch panel 1506, the arrow key 1502, and the home key 1504.

[Details]

The game according to the present embodiment is a match-type fighting game played by a player who operates a player character to perform attack motions such as punching or kicking and defense motions such as blocking attacks from a character (an opponent character) of an opponent in a match. The opponent is a player character operated by another player, but may be a computer-controlled character (NPC). Each player selects a character to use for playing from a predetermined character group (hereinafter referred to as a “candidate character group”) including a plurality of types of characters selectable as a player character.

The server system 1100 analyzes stats of a match from a result of the match in the executed game to present to the player. Accordingly, the server system 1100 performs (1) an individual evaluation process for performing an individual evaluation of gameplay with a player operating a player character as a target player with respect to each stat item based on motion content or a motion result of the player character during a match, (2) an overall evaluation process for performing an overall evaluation of each stat item based on the individual evaluation of each stat item, (3) a player-to-all comparison display control process for displaying the individual evaluation of each stat item in a comparable manner with the overall evaluation of each corresponding stat item, and (4) a player-to-player comparison display control process for displaying the individual evaluations of each stat item of the players who had the match in a comparable manner.

According to the present embodiment, the individual evaluation process, the overall evaluation process, the player-to-all comparison display control process, and the player-to-player comparison display control process are performed right after the end of the match. Accordingly, the individual evaluation of each stat item of each player is presented to the relevant player who finished the match in a comparable manner with the overall evaluation and also with the individual evaluation of the opponent player. Furthermore, in response to a separate display request operation requesting the display of the individual evaluation, the player-to-all comparison display control process is performed, and the individual evaluation of each stat item of the player who performed the display request operation is presented to the player in a comparable manner with the overall evaluation.

(1) Individual Evaluation Process

In the individual evaluation process, the gameplay of each player (hereinafter referred to as a “first player” and a “second player” as appropriate) in a match in a finished game is individually evaluated with respect to each stat item with each player as a target player in turn.

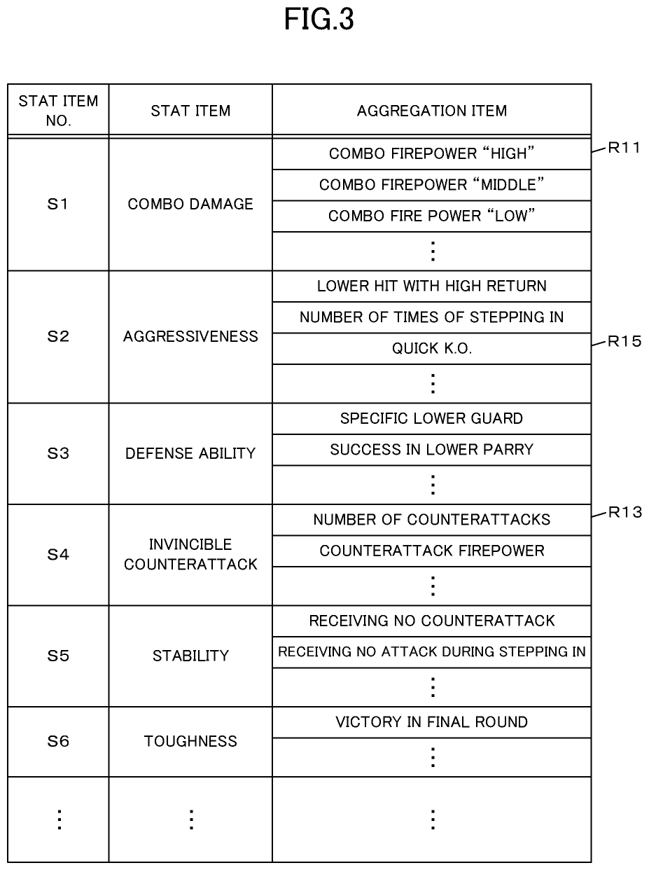

FIG. 3 is an example of stat items. According to the present embodiment, each stat item is defined by one or more of aggregation items as illustrated in FIG. 3. Each stat item is assigned with a stat item number as an identification number.

The aggregation item is previously defined based on the motion content or the motion result of the player character during the match in relation to the stat item. In particular, the aggregation item may include a type of each motion of an attack or defense, a type or a number of moves performed, a type or a number of moves received from an opponent, a success rate of an invincible counterattack, a number of moves requiring many frames for performing or for a stiff time, timing of each motion (information on whether the motion is made in an early stage of the match or near the end), a winning rate, or the like.

For example, a stat item “combo damage” is an item for evaluating magnitude of damage caused to the opponent by a combo attack, and includes an aggregation item relating to a degree of magnitude of the combo attack (combo firepower). A stat item “aggressiveness” includes an aggregation item of the motion content or the motion result relating to an evaluation of proficiency in an attack. A stat item “defense ability” includes an aggregation item of the motion content or the motion result relating to an evaluation of an ability to respond to an attack.

Furthermore, according to the game of the present embodiment, a stiff time is set to each motion made by the player character. The stiff time is a time required before the player character can start a next motion after executing a certain motion. Any input operation for the next motion is invalidated until the stiff time ends. Accordingly, from a viewpoint of the opponent, the stiff time is an “attack opportunity” that the opponent can hit an attack for sure without being blocked. A stat item “invincible counterattack” is an item for evaluating whether the player was able to cause damage without missing the attack opportunity due to the stiff time, or the magnitude of the damage caused by the invincible counterattack, and includes an aggregation item relating to the number of invincible counterattacks or firepower of the counterattack, for example.

Furthermore, according to the present embodiment, a procedure for calculating a unit score is set for each aggregation item included in the stat item. In particular, a number of times that a motion of motion content indicated by the relevant aggregation item is performed during the match is counted, and a point for each performance is multiplied by the number of times of performance to obtain the unit score. Or, a number of times that a motion result indicated by the relevant aggregation item is achieved during the match is counted, and a point for each achievement is multiplied by the number of times of achievement to obtain the unit score. Or, the number of times of performance or achievement is compared with a threshold for a threshold determination, and when the number exceeds the threshold, the unit score is added. Or, when the motion content indicated by the relevant aggregation item is performed during the match, or when the motion result indicated by the relevant aggregation item is achieved, the unit score is added. For example, as for a record R11 in FIG. 3, the number of combo attacks causing larger damage to the opponent is counted to obtain the unit score. As for a record R13, when the number of invincible counterattacks during the match exceeds a predetermined number, the unit score of a predetermined value is added. As for a record R15, when a time taken to knockout the opponent is less than a predetermined time period and it is determined that a “quick K.O.” is achieved, the unit score of a predetermined value is added. The procedure described herein is only an example, and the method of the individual evaluation is not especially limited.

After the unit score of each aggregation item is calculated as described above, the unit scores are added up for each stat item to obtain a score of each stat item.

Then, after the score of each stat item is calculated, the score is aggregated with the scores obtained from matches played by the target player before, and, for example, an average value of a total score is calculated as an aggregate score so as to calculate through aggregation the individual evaluation of each stat item relating to the target player. More specifically, according to the present embodiment, among the matches played by the target player before, the scores of the matches using the same player character as the player character used in a latest match are averaged to calculate the aggregate score. As a result, the individual evaluation of each stat item of the target player is calculated through the aggregation according to a type of used character. A total value or a median may be calculated instead of the average value.

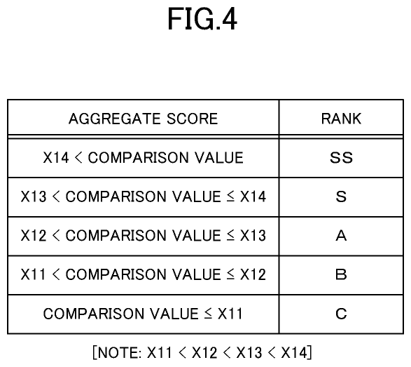

Then, the aggregate score is ranked. In order to rank the aggregate score, a previously prepared rank conversion table is referred to for identifying a rank corresponding to the aggregate score. FIG. 4 is an example of a data configuration of the score conversion table. As illustrated in FIG. 4, the rank conversion table is a data table where an allowable value of the aggregate score is divided into five value ranges respectively assigned with five ranks of “SS”, “S”, “A”, “B”, and “C” from highest to lowest. The conversion table is prepared for each stat item. The number of ranks is not limited to five, and may be four, six, or more.

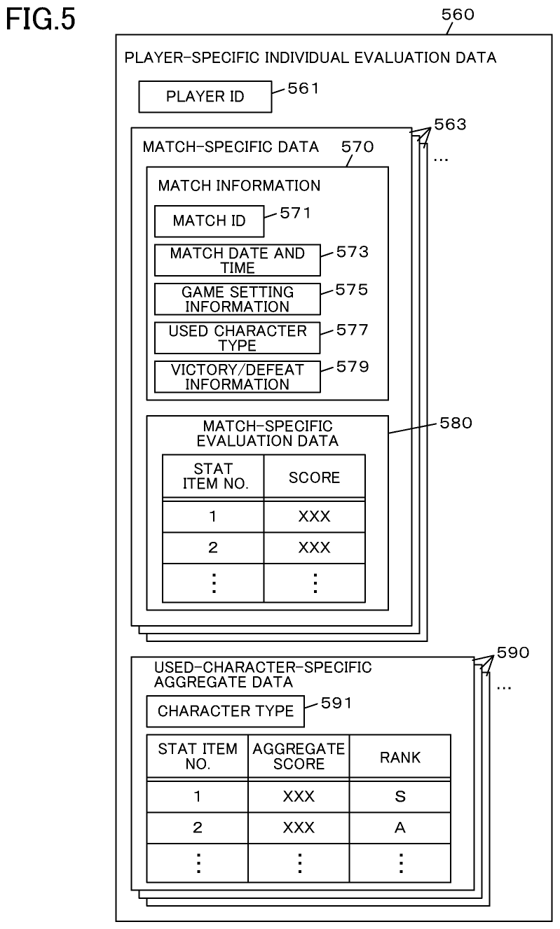

FIG. 5 is a diagram illustrating an example of a data configuration of player-specific individual evaluation data 560 including a result of the individual evaluation. The player-specific individual evaluation data 560 is prepared for each player, and generated and updated at any time in the individual evaluation process. As illustrated in FIG. 5, one piece of player-specific individual evaluation data 560 includes a player ID 561, match-specific data 563, and used-character-specific aggregate data 590. The match-specific data 563 is prepared for each match played by the player of the player ID 561. One piece of match-specific data 563 includes match information 570 and match-specific evaluation data 580.

The match information 570 stores a match ID 571, a match date and time 573, game setting information 575, a used character type 577, and victory/defeat information 579 of a relevant match.

The game setting information 575 stores various game settings such as a limited time period, the number of rounds, or a type of game stage of the relevant match. The game settings such as the limited time period, the number of rounds, or the type of game stage are set before the match starts. For example, the limited time period and the number of rounds may be previously set for each type of game stage, and the game settings may be set when the player selects the game stage. Alternatively, the player may be allowed to set the limited time period and the number of rounds, as well.

The used character type 577 stores a character type used by the player as the player character in the match. The victory/defeat information 579 stores flag information indicating whether the player is a winner or a loser in the match.

The match-specific evaluation data 580 stores a score of each stat item in the match calculated in the individual evaluation process right after the end of the match.

On the other hand, the used-character-specific aggregate data 590 is prepared for each character type 591 that the player has used in the matches. One piece of used-character-specific aggregate data 590 stores a latest aggregate score and rank of each stat item calculated for a relevant character in the individual evaluation process. According to the present embodiment, the aggregate score of each stat item in the used-character-specific aggregate data 590 is an average value of the scores of each stat item in the match-specific evaluation data 580 that are included in the same player-specific individual evaluation data 560, and that the relevant used character type 577 is the same as the character type 591.

(2) Overall Evaluation Process

In the overall evaluation process, an overall evaluation is performed for each stat item based on the individual evaluation of each stat item evaluated and calculated through the aggregation for each player in the individual evaluation process. For example, the overall evaluation is calculated according to the type of used character based on the individual evaluations of each stat item of respective players (all registered users) participating in the game.

According to the present embodiment, the overall evaluation process is performed subsequently to the individual evaluation process. The used-character-specific aggregate data 590 including the same character type 591 as the character type used by the target player in the latest match is read out from the player-specific individual evaluation data 560 of respective players. Then, an average value of the aggregate scores in the read-out used-character-specific aggregate data 590 is calculated for each stat item to reflect the individual evaluation of the target player for the latest match to the overall evaluation. That is, an overall average score of each stat item is an average value of the aggregate scores of each stat item in the used-character-specific aggregate data 590 of the same character type 591 in the player-specific individual evaluation data 560 of respective players.

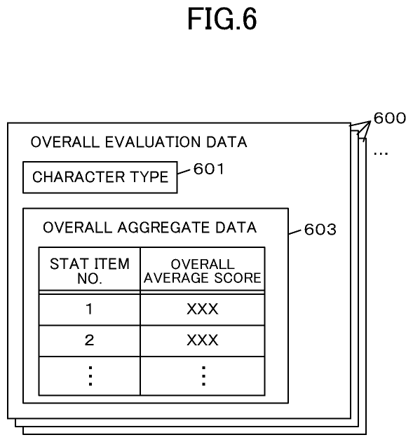

FIG. 6 is a diagram illustrating an example of a data configuration of overall evaluation data 600 including a result of the overall evaluation. The overall evaluation data 600 is prepared for each character in the candidate character group, and generated and updated in the overall evaluation process at any time. As illustrated in FIG. 6, one piece of overall evaluation data 600 includes a character type 601 and overall aggregate data 603. The overall aggregate data 603 stores a latest overall average score of each stat item calculated for the relevant character in the overall evaluation process.

(3) Player-to-All Comparison Display Control Process

In the player-to-all comparison display control process, a control for the “player-to-all comparison display” is performed, so that the individual evaluation of each stat item of a certain player (hereinafter referred to as a “display target player”) is compared with the overall evaluation.

In particular, in a case right after the end of the match, the control for the player-to-all comparison display is performed with each player (the first player and the second player) in the match as the display target player. On the player terminal 1500 of the first player, the control for the player-to-all comparison display between the individual evaluation of each stat item of the first player and the overall evaluation is performed. On the player terminal 1500 of the second player, the control for the player-to-all comparison display between the individual evaluation of each stat item of the second player and the overall evaluation is performed. Furthermore, in a case where the display request operation is performed, the control for the player-to-all comparison display is performed with the player who performed the display request operation as the display target player on the player terminal 1500 of this player.

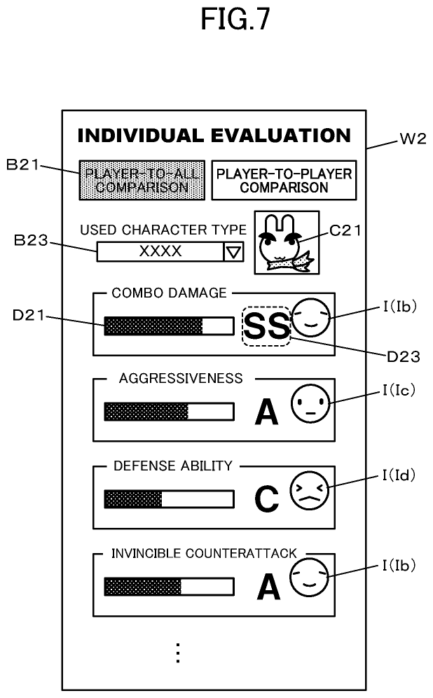

FIG. 7 is a diagram illustrating an example of the player-to-all comparison display. The player-to-all comparison display is performed on an individual evaluation screen W2 on the player terminal 1500 of the display target player, for example. As illustrated in FIG. 7, the individual evaluation screen W2 displays a list of the individual evaluations of the stat items calculated through the aggregation according to the type of used character with respect to the display target player. In FIG. 7, a gauge D21 and a rank D23 of the aggregate score are displayed as the individual evaluation of each stat item relating to the match played by the display target player using a character C21 as the player character. In the player-to-all comparison display right after the match, the character used by the display target player in the match is displayed as the character C21. However, upon selection of another used character type by a spin button B23, the individual evaluation of each stat item relating to the match played using another character as the player character can be displayed.

Then, the server system 1100 performs the control for the player-to-all comparison display when a player-to-all comparison button B21 is selected in the individual evaluation screen W2. As illustrated in FIG. 7, the player-to-all comparison display is performed by attaching a display body I corresponding to a difference between the individual evaluation and the overall evaluation in a field of the individual evaluation of each stat item.

Accordingly, in the player-to-all comparison display control process, the relevant used-character-specific aggregate data 590 is first read out from the player-specific individual evaluation data 560 of the display target player, and the overall aggregate data 603 is read out from the overall evaluation data 600 of the same character type 601. Then, an overall score is subtracted from the aggregate score to calculate a comparison value for each stat item.

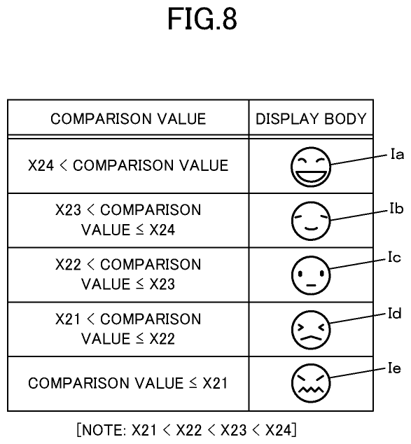

After the comparison value is calculated, the display body I is determined for each stat item. According to the present embodiment, a plurality of types of display bodies I are prepared as, for example, face icons with different expressions, and correspondence relations with value ranges of the comparison value are previously set. FIG. 8 is a setting example of display bodies I (Ia to Ie). Definition data of the display bodies I is prepared for each stat item. In the example in FIG. 8, an entire range of an allowable comparison value is divided into five value ranges, and the correspondence relations between the value ranges and the display bodies I are set. More specifically, each of the display bodies I illustrated in FIG. 8 is a face icon with an expression that changes brighter as the comparison value is higher, and darker as the comparison value is lower.

Then, the display body I is determined for each stat item in accordance with the definition data of the display bodies I illustrated in FIG. 8. After that, the display body I determined is displayed in the field of the corresponding stat item. In the example in FIG. 7, the individual evaluations of the “aggressiveness” and the “invincible counterattack” are both ranked as A. However, the display bodies attached are different. This indicates that the individual evaluation of the “invincible counterattack” attached with the display body Ib with a brighter expression is higher than the overall evaluation, and the individual evaluation of the “aggressiveness” attached with the display body Ic is moderate (see FIG. 8) compared with the overall evaluation.

With the player-to-all comparison display, the individual evaluation of each stat item based on the motion content or the motion result of the player character during the match can be presented to the display target player in a comparable manner with the overall evaluation of each stat item according to the same character. For example, this presentation can be implemented by attaching the display body I corresponding to the comparison value of each stat item between the individual evaluation and the overall evaluation. As a result, the player can recognize not only the individual evaluation of his/her own evaluated and calculated through the aggregation for each stat item, but also whether his/her individual evaluation is higher or lower than the overall evaluation by the expression of the display body I displayed in the same field.

(4) Player-to-Player Comparison Display Control Process

In the player-to-player comparison display control process, the control for the “player-to-player comparison display” is performed right after the end of the match with each player (the first player and the second player) in the match as the display target player, and the player-to-player comparison display displays the individual evaluations of each stat item of both players in a comparable manner.

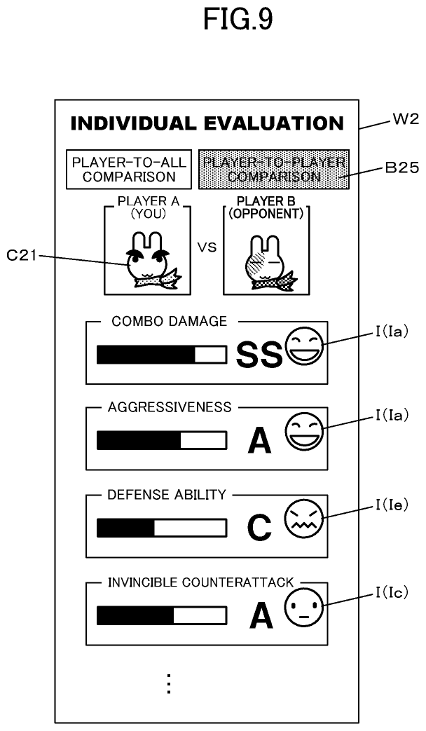

FIG. 9 is a diagram illustrating an example of the player-to-player comparison display. The player-to-player comparison display is performed on the individual evaluation screen W2 similarly to the player-to-all comparison display, for example. As illustrated in FIG. 9, the individual evaluation screen W2 displays a list of the individual evaluations of the stat items relating to the character C21 used by the display target player in the latest match.

Then, the server system 1100 performs the control for the player-to-player comparison display when a player-to-player comparison button B25 is selected in the individual evaluation screen W2. As illustrated in FIG. 9, the player-to-player comparison display is performed by attaching the display body I corresponding to a difference in the individual evaluation with respect to the opponent player in the field of the individual evaluation of each stat item.

Accordingly, in the player-to-player comparison display control process, the aggregate score of the opponent player is subtracted from the aggregate score of the display target player so as to calculate the comparison value for each stat item based on the used-character-specific aggregate data 590 of the display target player updated in the individual evaluation process after the end of the match and the used-character-specific aggregate data 590 of the opponent player updated as well.

Then, after the comparison value is calculated, the display body I is determined for each stat item by referring to the definition data of the display body, and the display body I determined is displayed in the field of the corresponding stat item.

With the player-to-player comparison display, the individual evaluation of each stat item of the first player is presented on the player terminal 1500 of the first player in a comparable manner with the individual evaluation of each stat item of the second player. On the other hand, the individual evaluation of each stat item of the second player can be presented on the player terminal 1500 of the second player in a comparable manner with the individual evaluation of each stat item of the first player. For example, this presentation can be implemented by attaching the display body I corresponding to the comparison value of each stat item between the individual evaluations of the players in the match. As a result, the player can recognize not only the individual evaluation of his/her own evaluated and calculated through the aggregation for each stat item, but also whether his/her individual evaluation is higher or lower than the individual evaluation of the opponent player by the expression of the display body I displayed in the same field. In the example in FIG. 9, although the individual evaluation of the “aggressiveness” is ranked as “A”, which indicates a moderate level, the display body Ia with a brightest expression is attached. This means that the individual evaluation of the display target player in relation to the “aggressiveness” is higher than the individual evaluation of the opponent.

[Functional Configuration]

1. Server System

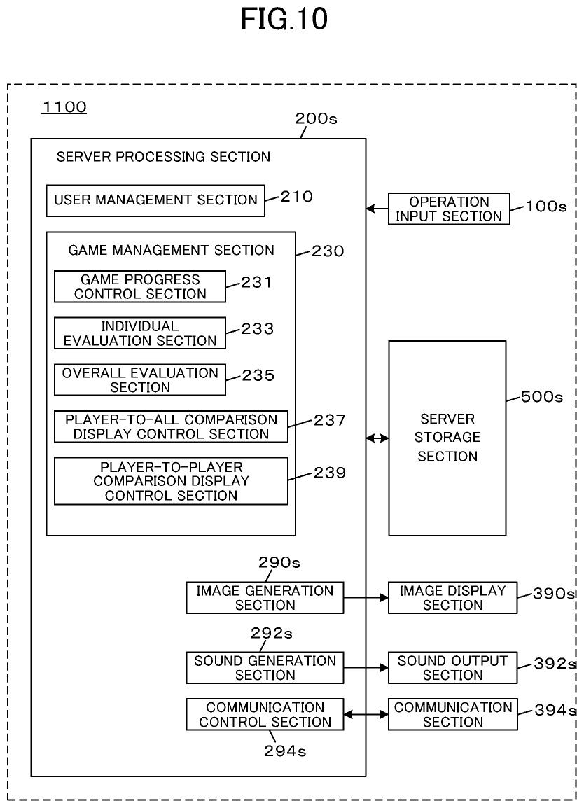

FIG. 10 is a block diagram illustrating an example of a functional configuration of the server system 1100. As illustrated in FIG. 10, the server system 1100 according to the present embodiment includes an operation input section 100s, a server processing section 200s, an image display section 390s, a sound output section 392s, a communication section 394s, and a server storage section 500s.

The operation input section 100s is a means for inputting various operations for system management, maintenance, and the like and can be implemented by, for example, a keyboard, a mouse, or a touch panel. The operation input section 100s corresponds to the keyboard 1106 and the touch panel 1108 in FIG. 1.

The server processing section 200s can be implemented, for example, by a processor including an arithmetic circuit such as a CPU, a GPU, an ASIC, or an FPGA, and an electronic component such as an IC memory. The server processing section 200s controls input/output of data between device sections including the operation input section 100s and the server storage section 500s. The server processing section 200s performs various calculation processes based on a predetermined program or data, an operation input signal from the operation input section 100s, and data received from the player terminal 1500 to integrally control the operation of the server system 1100. The server processing section 200s corresponds to the control board 1150 and the CPU 1151 thereon in FIG. 1.

The server processing section 200s includes a user management section 210, a game management section 230, an image generation section 290s, a sound generation section 292s, and a communication control section 294s.

The user management section 210 performs a process related to user registration and manages the data of each registered user (a player) associated with a player ID (an account). For example, the user management section 210 can perform an issuing process of issuing a unique player ID to a registered player, a registration information management process of registering and managing personal information for each player ID, and a use history management process of managing a history of login and logout or the like. Of course, any other management processes for other data associated with the player ID can be included as appropriate.

The game management section 230 performs various processes related to game execution management. The game according to the present embodiment is a client-server online game, and thus the game management section 230 communicates with the player terminal 1500 to perform a control of providing data required for gameplay. The game management section 230 includes a game progress control section 231, an individual evaluation section 233, an overall evaluation section 235, a player-to-all comparison display control section 237, and a player-to-player comparison display control section 239.

The game progress control section 231 communicates with the player terminal 1500 as needed to control progress of gameplay (a match) on the player terminal 1500, and performs a process related to a reflection of the gameplay.

The individual evaluation section 233 is a functional section that performs the individual evaluation process. According to the present embodiment, the individual evaluation process is performed right after the end of the match so as to perform the individual evaluation of the gameplay of each player (the first player and the second player) with respect to each stat item with each player who had the match in the game as the target player in turn. At this time, the individual evaluations of each stat item in relation to the matches of the target player are aggregated according to the type of used character so as to calculate through the aggregation the individual evaluation of each stat item of the target player according to the type of used character at every match.

The overall evaluation section 235 is a functional section that performs the overall evaluation process, and performs the overall evaluation of each stat item based on the individual evaluation of each stat item evaluated and calculated through the aggregation by the individual evaluation section 233. According to the present embodiment, the individual evaluations of each stat item of all registered users are aggregated according to the type of used character to calculate the overall evaluation of each stat item.

The player-to-all comparison display control section 237 is a functional section that performs the player-to-all comparison display control process, and performs a control for the player-to-all comparison display that displays the individual evaluation of each stat item of the display target player in a comparable manner with the overall evaluation.

The player-to-player comparison display control section 239 is a functional section that performs the player-to-player comparison display control process, and performs a control for the player-to-player comparison display that displays the individual evaluations of each stat item in a comparable manner between the players in the match as the display target players.

The image generation section 290s generates images related to the system management of the server system 1100 or the like, and outputs the images to the image display section 390s.

The sound generation section 292s is implemented by execution of an IC or software for generating and decoding sound data, and generates or decodes sound data of operational sounds related to the system management of the server system 1100 and video distribution, and BGM, for example. Sound signals related to the system management are output to the sound output section 392s.

The communication control section 294s performs communication connection and data processing for data communication with an external device (e.g., the player terminal 1500) through the communication section 394s to implement exchange of data with the external device.

The image display section 390s displays various screens for the system management based on the image signals input from the image generation section 290s. For example, the image display section 390s can be implemented by an image display device such as a flat panel display, a projector, or a head-mounted display. The image display section 390s corresponds to the touch panel 1108 in FIG. 1.

The sound output section 392s receives the sound signals input from the sound generation section 292s to emit corresponding sounds. The sound output section 392s corresponds to a speaker (not illustrated) included in the main body device 1101 or the touch panel 1108 in FIG. 1.

The communication section 394s connects to the network 9 to implement communication. For example, the communication section 394s can be implemented by a wireless communication device, a modem, a terminal adaptor (TA), a jack for wired communication cable, or a control circuit. The communication section 394s corresponds to the communication device 1153 in FIG. 1.

The server storage section 500s stores programs for causing the server system 1100 to operate to implement various functions included in the server system 1100 and data used during execution of the programs. The programs and the data are stored previously or temporarily at every process. For example, the server storage section 500s can be implemented by an IC memory such as a RAM or a ROM, a magnetic disk such as a hard disk, or an optical disk such as a CD-ROM or a DVD. The server storage section 500s corresponds to the IC memory 1152 and the storage 1140 in FIG. 1.

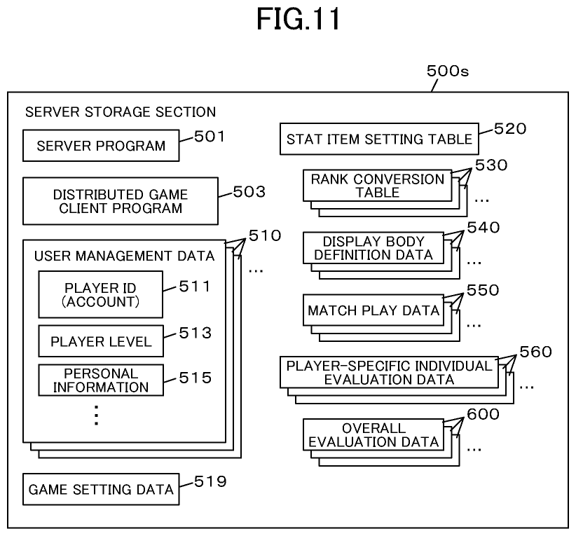

FIG. 11 is a diagram illustrating an example of programs and data stored in the server storage section 500s according to the present embodiment. The server storage section 500s according to the present embodiment stores a server program 501, a distributed game client program 503, user management data 510, game setting data 519, a stat item setting table 520, a rank conversion table 530, display body definition data 540, match play data 550, player-specific individual evaluation data 560, and overall evaluation data 600. The server storage section 500s may also store necessary data such as a timer, a counter, or various types of flags as appropriate.

The server program 501 is a program for causing the server processing section 200s to function as the user management section 210 and the game management section 230. The server program 501 may include programs for causing the server processing section 200s to function as the image generation section 290s, the sound generation section 292s, and the communication control section 294s as appropriate.

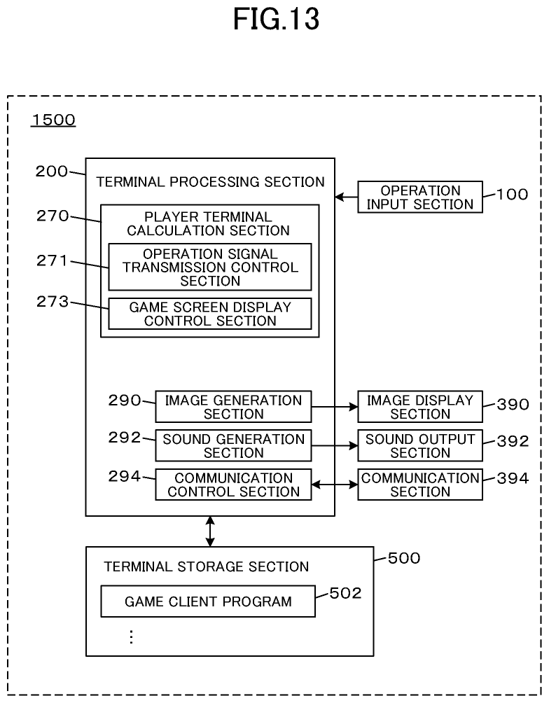

The distributed game client program 503 is an original of a game client program 502 (see FIG. 13) downloaded to the player terminal 1500.

The user management data 510 is prepared for each player who has registered as a user, and stores various types of data for management related to the gameplay of the player. In particular, one piece of user management data 510 includes a player ID 511 of the relevant player, a player level 513, and personal information 515 such as age and sex. The user management data 510 also includes a play history such as a play date and time or a play time, saved data related to a play status, or the like.

The game setting data 519 stores various types of setting data necessary for executing the game. For example, the game setting data 519 stores character setting data defining a type, various ability parameter values, model data, motion data used for motion control, or the like of each character in the candidate character group, object definition data related to various game objects such as an item that can be acquired by the player during a course of the game, stage setting data related to a setting of a game stage, or the like.

The stat item setting table 520 is a data table defining an aggregation item for each stat item, and includes, in association with a stat item number, the stat item and the aggregation item for the stat item as illustrated in FIG. 3.

The rank conversion table 530 is a table showing a correspondence relation between an aggregate score and a rank (see FIG. 4), and is prepared for each stat item.

The display body definition data 540 is definition data of a display body I used for the player-to-all comparison display and the player-to-player comparison display. According to the present embodiment, the display body definition data 540 is a table showing a correspondence relation between a comparison value and a display body (see FIG. 8), and is prepared for each stat item.

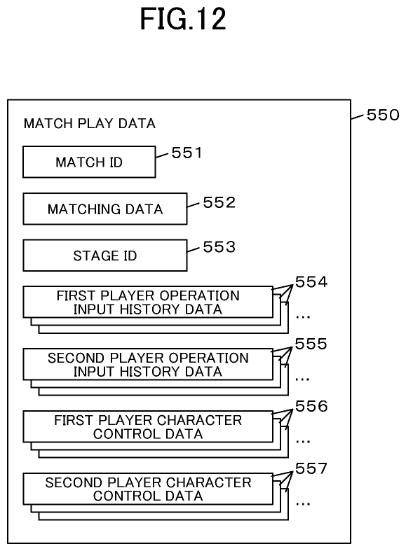

The match play data 550 is prepared for each game and stores various types of data describing a player of the game and a play status (a progress status) of the game. For example, as illustrated in FIG. 12, one piece of match play data 550 includes a match ID 551, matching data 552, a stage ID 553 indicating a type of game stage, first player operation input history data 554, second player operation input history data 555, first player character control data 556, and second player character control data 557.

The matching data 552 stores data of each player in a match in the game. In particular, the matching data 552 stores a player ID, a player name, a device ID of a player terminal 1500 used, a player character setting such as a type or an ability parameter value of a player character of each of the first player and the second player.

The first player operation input history data 554 stores information on operation input by the first player during the match in time series. The second player operation input history data 555 stores information on operation input by the second player during the match in time series.

The first player character control data 556 stores various types of data describing a latest state of the player character used by the first player in a game stage. For example, the first player character control data 556 includes position coordinates, a posture, an ability parameter value, a remaining number of hit points of the player character. The second player character control data 557 stores various types of data describing a latest state of the player character used by the second player in a game stage. Similarly, the second player character control data 557 includes position coordinates, a posture, an ability parameter value, a remaining number of hit points of the player character.

The player-specific individual evaluation data 560 is prepared for each player, and stores an individual evaluation of each stat item evaluated and calculated through the aggregation in relation to the player, as described referring to FIG. 5.

The overall evaluation data 600 is prepared for each character in the candidate character group, and stores an overall evaluation of each stat item calculated in relation to a relevant character from individual evaluations of each stat item of all registered users, as described referring to FIG. 6.

2. Player Terminal

FIG. 13 is a block diagram illustrating an example of a functional configuration of the player terminal 1500. As illustrated in FIG. 13, the player terminal 1500 includes an operation input section 100, a terminal processing section 200, an image display section 390, a sound output section 392, a communication section 394, and a terminal storage section 500.

The operation input section 100 is used by a player to input various operations, and can be implemented, for example, by a button switch, a joystick, a touch pad, a track ball, an accelerometer, a gyro sensor, or a CCD module. The operation input section 100 corresponds to the arrow key 1502, the home key 1504, and the touch panel 1506 in FIG. 2.

The terminal processing section 200 can be implemented, for example, by a processor including an arithmetic circuit such as a CPU, a GPU, an ASIC, or an FPGA, and an electronic component such as an IC memory. The terminal processing section 200 controls input/output of data between device sections including the operation input section 100 and the terminal storage section 500. The terminal processing section 200 performs various calculation processes based on a predetermined program or data, an operation input signal from the operation input section 100, and data received from the server system 1100 to integrally control the operation of the player terminal 1500. The terminal processing section 200 corresponds to the control board 1550 and the CPU 1551 thereon in FIG. 2. The terminal processing section 200 according to the present embodiment includes a player terminal calculation section 270, an image generation section 290, a sound generation section 292, and a communication control section 294.

The player terminal calculation section 270 performs various calculation processes to cause the player terminal 1500 to function as a terminal for the gameplay of the player. For example, the player terminal calculation section 270 includes an operation signal transmission control section 271 and a game screen display control section 273.

The operation signal transmission control section 271 performs a process of transmitting various types of data and request information to the server system 1100 in accordance with an operation input performed on the operation input section 100.

The game screen display control section 273 performs a control for displaying a game screen based on various types of data received from the server system 1100. For example, when the online game according to the present embodiment is implemented as a web game, the game screen display control section 273 can be implemented by web technology that actively controls the screen display using Java (registered trademark) and cascading style sheets (CSS) along with HTML with a web browser as a base, and by a plugin such as Adobe (registered trademark) Flash. Other methods may be employed, of course.

The image generation section 290 cooperates with the game screen display control section 273 to generate an image signal for displaying one game screen in every one frame time (e.g., 1/60th of a second) based on the various types of data received from the server system 1100, and to output the generated image signal to the image display section 390. For example, the image generation section 290 can be implemented, for example, by a processor such as a GPU or a digital signal processor (DSP), a video signal IC, a program such as a video codec, or a drawing frame IC memory such as a frame buffer.

The sound generation section 292 is implemented, for example, by a processor such as a digital signal processor (DSP) or a sound synthesizing IC, or an audio codec for playing a sound file. The sound generation section 292 generates sound signals for sound effects, BGM, and various types of operational sounds related to the game, and outputs the generated signals to the sound output section 392.

The communication control section 294 establishes a communication connection and performs data processing for data communication with an external device (e.g., the server system 1100) through the communication section 394, and implements exchange of data with the external device.

The image display section 390 displays various screens such as a game screen based on the image signals input from the image generation section 290. For example, the image display section 390 can be implemented by an image display device such as a flat panel display, a projector, or a head-mounted display. The image display section 390 corresponds to the touch panel 1506 in FIG. 2.

The sound output section 392 emits sounds such as sound effects or BGM related to the game, based on the sound signals input from the sound generation section 292. The sound output section 392 corresponds to the speaker 1510 in FIG. 2.

The communication section 394 connects to the network 9 to implement communication. For example, the communication section 394 can be implemented by a wireless communication device, a modem, a TA, a jack for wired communication cable, a control circuit, or the like. The communication section 394 corresponds to the wireless communication module 1553 in FIG. 2.

The terminal storage section 500 stores programs for causing the player terminal 1500 to operate to implement various functions included in the player terminal 1500 and data used during the execution of the programs. The programs and the data are stored previously or temporarily at every process. For example, the terminal storage section 500 can be implemented by an IC memory such as a RAM or a ROM, a magnetic disk such as a hard disk, or an optical disk such as a CD-ROM or a DVD. The terminal storage section 500 corresponds to the IC memory 1552 and the memory card 1540 in FIG. 2.

The terminal storage section 500 stores the game client program 502. The game client program 502 is a program for causing the terminal processing section 200 to function as the player terminal calculation section 270. The game client program 502 may be an exclusive client program depending on a technique and method for implementing an online game or include a web browser program and a plugin that implements an interactive image display. According to the present embodiment, the game client program 502 is a copy of the distributed game client program 503 (see FIG. 11) provided from the server system 1100.

[Flow of Processes]

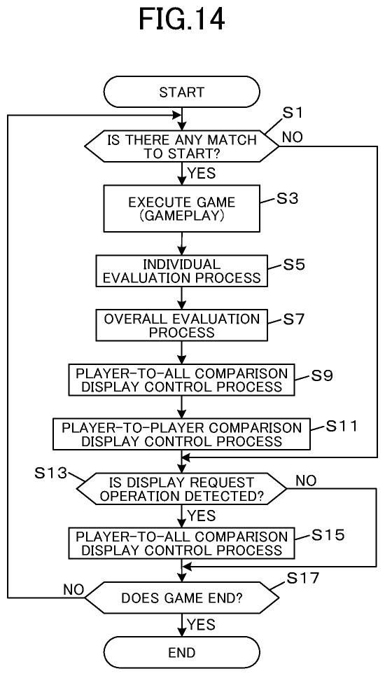

FIG. 14 is a flowchart illustrating a flow of processes of the server system 1100. The flow of processes as described herein is implemented by the server processing section 200s reading out and executing the server program 501.

In the server system 1100, when there are players ready to play the game, and the game is started (step S1: YES), the game progress control section 231 executes the game, and controls the progress of the gameplay on the player terminal 1500 of each player in the match (step S3).

Then, after the match ends, the individual evaluation section 233 performs the individual evaluation process for performing the individual evaluation of each stat item in relation to the gameplay of each player (the first player and the second player) (step S5). Then, the overall evaluation section 235 performs the overall evaluation process for performing the overall evaluation of each stat item based on the individual evaluation of each stat item evaluated and calculated through the aggregation at the step S5 (step S7).

Then, the player-to-all comparison display control section 237 performs the player-to-all comparison display control process for controlling the player-to-all comparison display (step S9). At this step, the first player and the second player are display target players. The player-to-all comparison display control section 237 performs the control for displaying the individual evaluation of each stat item of the first player in a comparable manner with the overall evaluation on the player terminal 1500 of the first player, and the control for displaying the individual evaluation of each stat item of the second player in a comparable manner with the overall evaluation on the player terminal 1500 of the second player.

Furthermore, the player-to-player comparison display control section 239 performs the player-to-player comparison display control process for controlling the player-to-player comparison display (step S11). At this step, the player-to-player comparison display control section 239 performs the control for displaying the individual evaluation of each stat item of the first player in a comparable manner with the individual evaluation of each stat item of the second player on the player terminal 1500 of the first player, and the control for displaying the individual evaluation of each stat item of the second player in a comparable manner with the individual evaluation of each stat item of the first player on the player terminal 1500 of the second player.

Furthermore, upon detection of a separate display request operation on a menu screen or the like (step S13: YES), the player-to-all comparison display control section 237 performs the player-to-all comparison display control process for controlling the player-to-all comparison display (step S15). At this step, a player who is using the player terminal 1500 on which the display request operation was performed is set as the display target player, and the player-to-all comparison display control section 237 performs the control for displaying the individual evaluation of each stat item of this player in a comparable manner with the overall evaluation on the player terminal 1500 of this player.

After this, unless termination of the flow of the processes is determined (step S17: NO), the flow returns to the step S1 to repeat the flow of the processes described above.

As described above, according to the present embodiment, the individual evaluation of each stat item can be evaluated and calculated through the aggregation in relation to the players in the match every time the match ends. Furthermore, reflecting the individual evaluation of each stat item in the overall evaluation enables the overall evaluation of each stat item based on the individual evaluations of each stat item of respective players participating in the game. At this time, the individual evaluation can be performed according to the type of used character, and the overall evaluation can be performed according to the type of used character. Then, for the player who had the match, the individual evaluation of the player can be displayed in a comparable manner with the overall evaluation based on the individual evaluation, and with the individual evaluation of the opponent player. As a result, the stats of the match obtained by evaluating and analyzing the gameplay of the player can be presented to the player in a comparable manner with the evaluation of the gameplay of other players.

The modes to which the present disclosure is applicable are not limited to the above-described embodiment, and the components can be added, omitted, or changed as appropriate.

### Modification Example 1

For example, a mode of the player-to-all comparison display and the player-to-player comparison display is not limited to a display mode using the display bodies I. For example, the player-to-all comparison display may be controlled by displaying the individual evaluation (the aggregate score and the rank) and the overall evaluation (the overall average score) side by side for each stat item so as to present both the individual evaluation and the overall evaluation in a comparable manner to the display target player. This display mode may be applied to the player-to-player comparison display, and the aggregate scores and the ranks of respective players may be displayed side by side for each stat item so as to present the aggregate scores and the ranks of both players in a comparable manner to the display target player.

### Modification Example 2

Furthermore, according to the embodiment described above, the individual evaluation is performed for each stat item based on the motion content and the motion result of the player character during the match, and the individual evaluation obtained is aggregated with the individual evaluations of each stat item in the previous matches played by the player. Then, the individual evaluation of each stat item (the aggregate score and the rank of each stat item) calculated through the aggregation is displayed in a comparable manner with the overall evaluation (the overall average score of each stat item), or the individual evaluation (the aggregate score and the rank of each stat item) of the opponent.

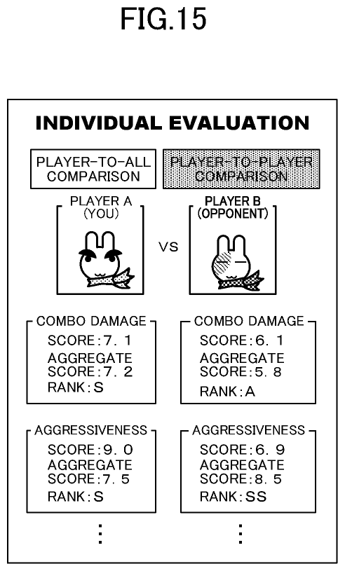

However, the individual evaluation of each stat item (the score of each stat item) obtained by evaluating only the latest match without the aggregation with the previous matches may be compared with the overall evaluation. In addition, the scores of each stat item obtained by evaluating only the latest match in relation to the players in the match may be displayed in a comparable manner. In such a case, the player-to-all comparison display and the player-to-player comparison display may adopt the display mode to display the score of each stat item and the overall average score side by side, or the scores of each stat item of the players in the match side by side, as in the modification example 1. Furthermore, as for the player-to-player comparison display, the score of each stat item of each player may be appended with the aggregate score and the rank of each stat item. FIG. 15 is a diagram illustrating an example of the player-to-player comparison display in the present modification example. Numerical values of the scores or the like are only examples.

In the example in FIG. 15, as for the “aggressiveness”, the rank of the opponent player is higher. On the other hand, in the latest match, the score of the player is higher than the score of the opponent player, which shows that the player was able to suppress a favorite invincible counterattack of the opponent player during the match. Although it is not shown in the drawings, when the player-to-all comparison display is displayed in the similar mode, the score of each stat item relating to the latest match, the aggregate score, and the rank can be presented to the display target player in a comparable manner with the overall average score. As a result, as for a stat item that has a low aggregate score and rank and is a weak point of the player, the player can focus on the latest score and see whether the score is higher or lower than the overall average score, for example.

### Modification Example 3

Furthermore, according to the present embodiment, the individual evaluation and the overall evaluation are performed according to the type of used character, and then the player-to-all comparison display is controlled. However, the evaluation may be performed according to a game setting relating to the match. The game setting may be the limited time period of the match, the number of rounds, or the type of game stage, for example. The individual evaluation of each stat item may be evaluated and calculated through the aggregation according to any one of these game settings, and the overall evaluation may be calculated according to the same setting.

In particular, assume that the evaluation is performed according to the limited time period. In the individual evaluation process, the game setting information 575 in the player-specific individual evaluation data 560 of the target player is referred to, and the match-specific data 563 including the same setting of the limited time period as the setting in the latest finished match are extracted. Then, the extracted data are aggregated with the score of each stat item calculated for the latest match so as to calculate the aggregate score and the rank for each stat item. As a result, the individual evaluation of each stat item of the player in the match is calculated through the aggregation according to the limited time period. At this time, similarly to the embodiment described above, the individual evaluation may be calculated according to the type of used character.

Then, in the overall evaluation process, the overall average score is calculated from the individual evaluations of each stat item evaluated and calculated through the aggregation according to the limited time period in relation to the respective players in the individual evaluation process, and the calculated overall average score is set as the overall evaluation according to the limited time period. In such a case as well, the overall evaluation may be calculated according to the type of used character.

Then, in the player-to-all comparison display control process, the individual evaluation of each stat item according to the limited time period of the latest match evaluated and calculated through the aggregation in relation to the target player is displayed in a comparable manner with the overall evaluation of each stat item according to the same limited time period.

The individual evaluation may be calculated through the aggregation according to a combination of two or three of the game settings including the limited time period, the number of rounds, and the type of game stage. Then, the overall evaluation may be performed according to the same combination of these game settings, and the player-to-all comparison display may be controlled according to the same combination of these game settings. In particular, the individual evaluation is calculated through the aggregation in relation to the matches including all the two or three game settings. Then, the overall evaluation is calculated based on the individual evaluation, and the comparison display of the individual evaluation and the overall evaluation is controlled.

As a result, the individual evaluation of each stat item can be presented to the player in a comparable manner with the overall evaluation in relation to the matches including the same game settings.

### Modification Example 4

Furthermore, when a game event of a match is held regularly or irregularly in relation to the game, the individual evaluation may be calculated through the aggregation according to a type of game event. Then, the overall evaluation may be calculated according to the type of game event, and the player-to-all comparison display may be controlled according to the type of game event. The game event includes a game event such as a tournament in which recruited participants play matches, a competition for competing for a game score of a match, or a game event that gives a special reward such as prize money or a prize to participants who played a match.

Furthermore, when the tournament or the competition described above includes a game stage (a match stage) that changes as the participant wins and advances, the individual evaluation may be calculated through the aggregation for each match stage, the overall evaluation may be calculated for each match stage, and the player-to-all comparison display may be controlled for each match stage.

Alternatively, the individual evaluations may be calculated through the aggregation separately for a match in the game event such as the tournament or the competition described above and for an ordinary match. Then, the individual evaluation of the match in the game event and the individual evaluation of the ordinary match may be displayed in a comparable manner. As a result, the player can see whether the player is good at playing the match in the game event (whether the player is strong), or not (whether the player is weak).

### Modification Example 5

Furthermore, the individual evaluations of the same player at different timing may be displayed in a comparable manner. For example, a current score of each stat item of the display target player and a score of each stat item at given timing in the past (e.g., a week before, a month before, or half a year before) may be displayed in a comparable manner. In such a case, in the server system 1100, the game management section 230 serving as a third comparison control section performs a control for displaying a result of the individual evaluation at first timing and a result of the individual evaluation at second timing in a comparable manner for each stat item. As a result, the current individual evaluation of each stat item of the player can be presented to the player in a comparable manner with the individual evaluation of each stat item in the past.

### Modification Example 6

Furthermore, according to the embodiment described above, the overall evaluation is performed using the individual evaluations of all registered users. However, the overall evaluation may be performed using the individual evaluations of part of entire players. For example, the overall evaluation may be calculated using the individual evaluations of members of a group that the target player belongs to.

### Modification Example 7

Furthermore, according to the embodiment described above, in the player-to-player comparison display, the individual evaluations of each stat item between the players who had the match are displayed in a comparable manner. However, instead of the opponent player, the individual evaluations of each stat item between the player and any other player serving as a comparison target player may be displayed in a comparable manner. For example, the comparison display may be performed with a player enrolled in a friend list of the display target player as the comparison target player, or with a player who had the match with the display target player before as the comparison target player. Alternatively, upon acceptance of a selection operation of the player from the display target player, the selected player may be set as the comparison target player. The comparison display may be performed in the display mode using the display bodies I as in the embodiment described above, or in the display mode for displaying the individual evaluations of each stat item of both players side by side as in the modification examples 1 and 2.

### Modification Example 8

Furthermore, according to the embodiment described above, the comparison display between the individual evaluation and the overall evaluation, and the comparison display between the individual evaluations of the players are performed right after the end of the match. However, timing of the comparison display is not particularly limited. For example, each of the comparison display may be performed right before the match starts. Furthermore, a menu for requesting each of the comparison display may be prepared, and the comparison display may be performed upon selection of the menu.

### Modification Example 9

Furthermore, according to the embodiment described above, the individual evaluation of each stat item is performed according to the type of used character, and the overall evaluation of each stat item is performed according to the same type of used character. However, the individual evaluation may be performed according to a combination of the type of used character and the type of opponent character of the opponent, and the overall evaluation may be performed according to the same combination.

In particular, the individual evaluation of each stat item is calculated for each player according to the combination of the used character used by the player in the match and the opponent character in the match. Then, the overall evaluation is calculated through the aggregation of the individual evaluations of respective players according to the combination of the used character and the opponent character. Then, the individual evaluation according to the combination of the used character and the opponent character may be displayed in a comparable manner with the overall evaluation calculated according to the same combination, or the individual evaluation of another player calculated according to the same combination.

### Modification Example 10

The game that the present disclosure is applicable to is not limited to a match game where characters fight against each other such as the match-type fighting game according to the embodiment described above. For example, in a single-play time-attack racing game, the individual evaluation may be performed with items such as “acceleration”, “course taking”, or “cornering” as the stat items, and the comparison display may be performed with respect to the overall evaluation of each of these stat items, or the individual evaluation of each of these stat items of another player.

Although only some embodiments of the present disclosure have been described in detail above, those skilled in the art will readily appreciate that many modifications are possible in the embodiments without materially departing from the novel teachings and advantages of this disclosure. Accordingly, all such modifications are intended to be included within scope of this disclosure.

What is claimed is:

1. A computer system comprising:
at least one processor or circuit programmed to perform:
an individual evaluation of gameplay of a target player for each stat item based on any one of motion content and a motion result of a player character during a game, the target player being a player operating the player character;
an overall evaluation of the each stat item based on a result of the individual evaluation of the each stat item of each player; and
a first comparison display control for performing comparison display of the each stat item between the result of the individual evaluation and a result of the overall evaluation in relation to the target player.

2. The computer system as defined in claim 1, wherein performing the individual evaluation includes
performing the individual evaluation for every gameplay of the game, and
aggregating results of the individual evaluation of the each stat item of every gameplay in relation to the target player so as to calculate through aggregation the result of the individual evaluation of the each stat item of the target player.

3. The computer system as defined in claim 1, wherein
the player character is a used character selected from a predetermined character group by the player and used in the game by the player,
performing the individual evaluation includes performing the individual evaluation according to a type of used character,
performing the overall evaluation includes performing the overall evaluation according to the type of used character, and
performing the first comparison display control includes performing the comparison display according to the used character of the target player.

4. The computer system as defined in claim 1, wherein
the player character is a used character selected from a predetermined character group by the player and used in the game by the player,
the game is a match game where characters selected from the character group have a match,
performing the individual evaluation includes performing the individual evaluation according to a combination of a type of the used character and a type of a opponent character,
performing the overall evaluation includes performing the overall evaluation according to the combination of the type of the used character and the type of the opponent character, and
performing the first comparison display control includes performing the comparison display according to the combination of the used character of the target player and the opponent character in the match.

5. The computer system as defined in claim 1, wherein the at least one processor or circuit is further programmed to perform
a second comparison display control for performing comparison display between a result of the individual evaluation of the each stat item of a first player and a result of the individual evaluation of the each stat item of a second player.

6. The computer system as defined in claim 1, wherein the at least one processor or circuit is further programmed to perform
a third comparison display control for performing comparison display of the each stat item between a result of the individual evaluation at first timing and a result of the individual evaluation at second timing in relation to the target player.

7. The computer system as defined in claim 1, wherein
the game is a match game where characters selected from a predetermined character group have a match, and a game setting relating to the match is variable,
performing the individual evaluation includes performing the individual evaluation according to a variable game setting,
performing the overall evaluation includes performing the overall evaluation according to the variable game setting, and
performing the first comparison display control includes performing the comparison display according to the game setting of the target player.

8. The computer system as defined in claim 7, wherein the game setting is at least any one of a limited time period, a number of rounds, and a type of game stage of the match.

9. The computer system as defined in claim 1, wherein
the game is a match game where characters selected from a predetermined character group have a match, and a game event relating to the match is held,
performing the individual evaluation includes performing the individual evaluation according to a type of the game event,
performing the overall evaluation includes performing the overall evaluation according to the type of the game event, and
performing the first comparison display control includes performing the comparison display according to the type of the game event of the target player.

10. A game system comprising:
a player terminal of each player; and
a server system that is the computer system as defined in claim 1 configured to be able to communicate with the player terminal.

11. A control method executed by a computer system, the method comprising performing:
an individual evaluation of gameplay of a target player for each stat item based on any one of motion content and a motion result of a player character during a game, the target player being a player operating the player character;
an overall evaluation of the each stat item based on a result of the individual evaluation of the each stat item of each player; and
a first comparison display control for performing comparison display of the each stat item between the result of the individual evaluation and a result of the overall evaluation in relation to the target player.
